(19) United States
(12) Patent Application Publication
(10) Pub. No.: US 2011/0220250 A1
(43) Pub. Date: Sep. 15, 2011

(54) METHOD FOR ORDERING A DISORDERED ALLOY AND MAGNETIC MATERIAL MADE THEREBY

(75) Inventors: Chih-Huang Lai, Hsinchu (TW); Wei-Chih Wen, Hsinchu (TW)

(73) Assignee: National Tsing Hua University, Hsinchu (TW)

(21) Appl. No.: 12/949,215

(22) Filed: Nov. 18, 2010

(30) Foreign Application Priority Data
Mar. 9, 2010 (TW) 099106760

(51) Int. Cl. H01F 1/047; H01F 1/04

(52) U.S. Cl. 148/121; 148/301

(57) ABSTRACT

A method for ordering a disordered alloy includes: (a) forming a layer of a first alloy on a substrate, the first alloy being composed of a first metal and a second metal, and having a meta-stable phase of a face-centered cubic (FCC) crystal structure; (b) forming a layer of a third metal on the layer of the first alloy to form a layer unit including the layer of the first alloy and the layer of the third metal; and (c) annealing the layer unit to cause interdiffusion of atoms of the first and third metals between the layer of the first alloy and the layer of the third metal so as to form an ordered second alloy composed of the second and third metals. The first metal is insoluble in the second alloy composed of the second and third metals, and has a diffusion constant greater than those of the second and third metals.

### CROSS-REFERENCE TO RELATED APPLICATION

This application claims priority of Taiwanese application No. 099106760, filed on Mar. 9, 2010.

### BACKGROUND OF THE INVENTION

1. Field of the Invention

This invention relates to a method for ordering a disordered alloy and a magnetic material made thereby.

2. Description of the Related Art

The FePt alloy which has an ordered phase (or L1₀ phase), i.e., a face-centered tetragonal (FCT) structure, has become a preferred choice for a magnetic recording material of a perpendicular magnetic recording (PMR) medium because of superior magnetocrystalline anisotropy energy (Ku) and high coercive field (Hc) thereof. Usually, the FePt alloy films formed by sputtering techniques at ambient temperature have a disordered phase, i.e., a face-centered-cubic (FCC) structure, and are required to be annealed under an elevated temperature as high as 550° C. so as to be transformed into the FCT structure and be used in the PMR medium.

Referring to FIG. 1, a conventional PMR medium 1 as disclosed in Taiwanese Patent No. 312151 includes a substrate 11, a base layer 12 formed on the substrate 11 and made from a material selected from the group consisting of Cr, Ag and the alloy thereof, a Pt buffer layer 13 that is formed on the base layer 12 and that has a layer thickness of about 2 nm, and a magnetic recording layer 14 that has a layer thickness of about 20 nm and that is made from an Ag-doped FePt alloy. The annealing temperature for the magnetic recording layer 14 of the conventional PMR media 1 is 450° C. The coercive field (Hc) of the conventional PMR media 1 can vary from 2.0 kOe to 4.5 kOe by adjusting the layer thickness of the base layer 12 ranging from 0 nm to 110 nm. Although, in the Taiwanese patent, the annealing temperature for the conventional PMR medium 1 has been decreased from 550° C. to 450° C., it is still too high and can result in damage to semiconductor components to which the conventional PMR medium 1 is integrated.

### SUMMARY OF THE INVENTION

Therefore, the object of the present invention is to provide a method for ordering a disordered alloy that can overcome the aforesaid drawbacks associated with the prior art.

According to one aspect of this invention, a method for ordering a disordered alloy comprises:

(a) forming a layer of a first alloy on a substrate, the first alloy being composed of a first metal and a second metal, and having a meta-stable phase of a face-centered cubic (FCC) crystal structure;

(b) forming a layer of a third metal on the layer of the first alloy to form a layer unit including the layer of the first alloy and the layer of the third metal; and

(c) annealing the layer unit to cause interdiffusion of atoms of the first and third metals between the layer of the first alloy and the layer of the third metal so as to form an ordered second alloy composed of the second and third metals,

wherein the first metal is insoluble in the second alloy composed of the second and third metals, and has a diffusion constant greater than those of the second and third metals.

According to another aspect of this invention, a magnetic material made by the aforesaid method includes: a plurality of magnetic crystallites composed of a second alloy that includes second and third metals and that has an ordered crystal structure, the second metal of the second alloy being selected from the group consisting of Pt and Pd, the third metal of the second alloy being selected from the group consisting of Fe, Co, and Ni; and a segregation composed of Ag or Au and formed in the grain boundaries or the surface of the magnetic crystallites.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a cross-sectional view showing a conventional PMR medium;

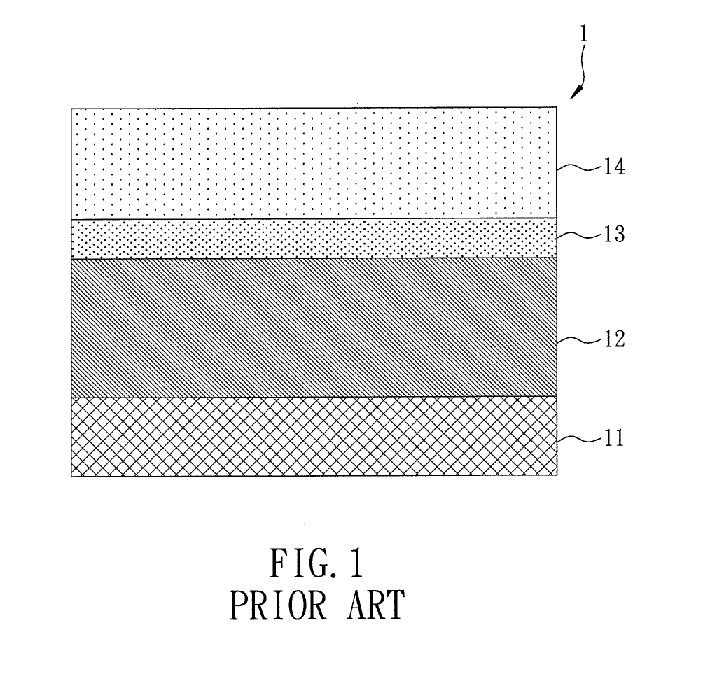

FIG. 2 is a schematic view illustrating a magnetic material formed by a preferred embodiment of a method for ordering a disordered alloy according to the present invention;

FIG. 3 is an X-Ray Diffraction (XRD) plot to illustrate the crystal structure transformation of the FePt(Ag) alloy under an elevated temperature of an example of this invention; and

FIG. 4 is a plot of hysteresis loops to illustrate the magnetic property of the FePt alloy of the example of this invention.

### DETAILED DESCRIPTION OF THE PREFERRED EMBODIMENTS

The preferred embodiment of a method for ordering a disordered alloy according to the present invention comprises: forming a layer of a first alloy on a substrate, the first alloy being composed of a first metal and a second metal, and having a meta-stable phase of face-centered cubic (FCC) crystal structure; forming a layer of a third metal on the layer of the first alloy to form a layer unit including the layer of the first alloy and the layer of the third metal; alternately repeating the steps of forming the layer of the first alloy and the layer of the third metal so as to form a plurality of layer units; and annealing the layer units and the substrate to cause interdiffusion of atoms of the first and third metals between the layer of the first alloy and the layer of the third metal so as to form a second alloy composed of the second and third metals.

The first metal is insoluble in the second alloy composed of the second and third metals, and has a diffusion constant greater than those of the second and third metals.

Preferably, the first metal is selected from the group consisting of Au and Ag, and the second and third metals are independently selected from a first group consisting of Fe, Co, and Ni or a second group consisting of Pt and Pd, with the proviso that the second metal and the third metal cannot be selected from the same group at the same time. More preferably, the second metal is selected from the second group consisting of Pt and Pd, and the third metal is selected from the first group consisting of Fe, Co, and Ni.

Preferably, a total layer thickness of the layer unit(s) ranges from 5.0 nm to 21.0 nm.

Preferably, in the layer unit, an atomic ratio of the first metal to the second metal ranges from 0.3 to 1, and an atomic ratio of the third metal to the second metal ranges from 1 to 1.1.

It should be noted that the layer thickness of each layer of the layer unit(s) and the amount of the layer unit(s) vary with the desired total layer thickness of the layer unit(s) and the atomic ratios of the metals of the layer unit(s). In an example of the present invention, the first metal is Ag, the second metal is Pt, the third metal is Fe, and the desired total layer thickness of the layer unit(s) is 10.32 nm. To obtain the desired thickness of the layer unit(s), in the example of this invention, the layer thicknesses of the layer of the first alloy and the third metal are 6.53 nm and 3.79 nm respectively so that the amount of the layer unit is 1. Alternatively, the amount of the layer unit can be 2, so that the layer thicknesses of the layer of the first alloy and the third metal are reduced to about 3.27 nm and 1.9 nm, respectively.

Preferably, the annealing temperature used in the preferred embodiment of the present invention ranges from 300° C. to 350° C.

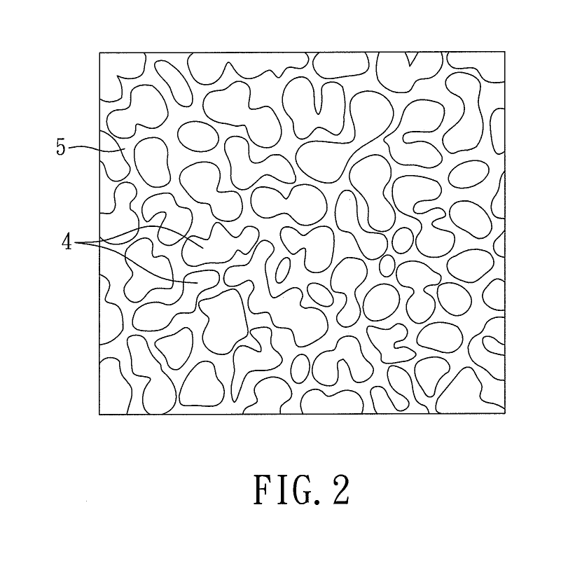

Referring to FIG. 2, a magnetic material made from the preferred embodiment of the method according to the present invention includes a plurality of magnetic crystallites 4 composed of the second alloy and having an ordered crystal structure, and a segregation 5 composed of the first metal formed in the grain boundaries or the surface of the magnetic crystallites.

The following example is provided to illustrate the merits of the preferred embodiment of the invention, and should not be construed as limiting the scope of the invention.

### Example

An AgPt alloy layer with a layer thickness of 6.53 nm was deposited onto a Si/SiO₂ substrate by DC magnetron sputtering under room temperature (i.e. 25° C.). A Fe layer having a layer thickness of 3.79 nm was then deposited on the AgPt layer under the same condition. The total layer thickness of the AgPt layer and the Fe layer, i.e., the layer unit, was 10.32 nm.

The layer unit and the substrate were examined by a heating X-ray diffractormeter (HT-XRD) equipped with an in-situ heating apparatus. The heating process was performed under a rate of temperature change of 100° C./min, and the temperature was held at 100° C., 200° C., 300° C. and 350° C. for time periods of 20 minutes respectively.

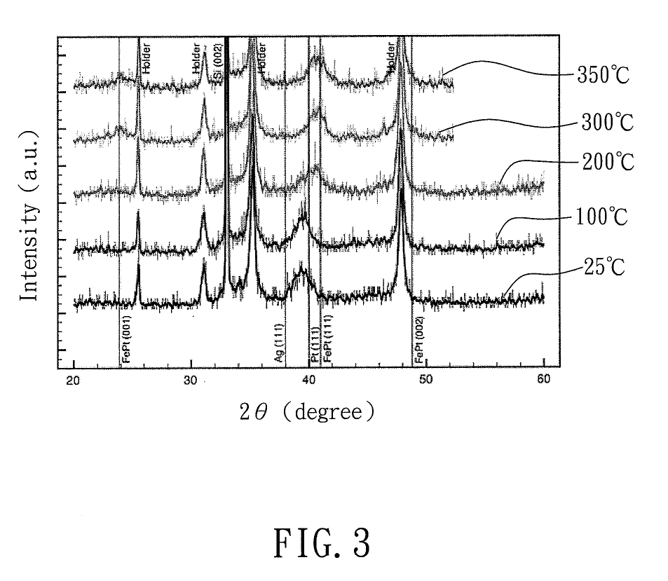

The XRD curves shown in FIG. 3 illustrate the transformation of the crystal structure of the layer unit including the AgPt layer and the Fe layer. The diffraction peaks found at 2θ of about 39.2 degrees of the XRD curves at 25° C. and 100° C. demonstrate that the meta-stable phase of AgPt was a face-centered cubic (FCC) crystal structure phase. The diffraction peak of Pt (111) found at 2θ of about 40 degrees of the XRD curve at 200° C., with reference to No. 43-1359 and No. 02-1167 of JCPDF cards (not shown), demonstrates the decomposition of the meta-stable phase of the AgPt alloy. The diffraction peaks of FePt (001) and FePt (111) found at 2θ of about 24 and 41 degrees of the XRD curves at 300° C. and 350° C., with reference to No. 43-1359 and No. 02-1167 of JCPDF cards (not shown), demonstrate the diffusion of the Fe atoms of the Fe layer into the AgPt layer and the formation of an ordered face-centered tetragonal (FCT) structure of FePt, i.e. the L1₀ phase.

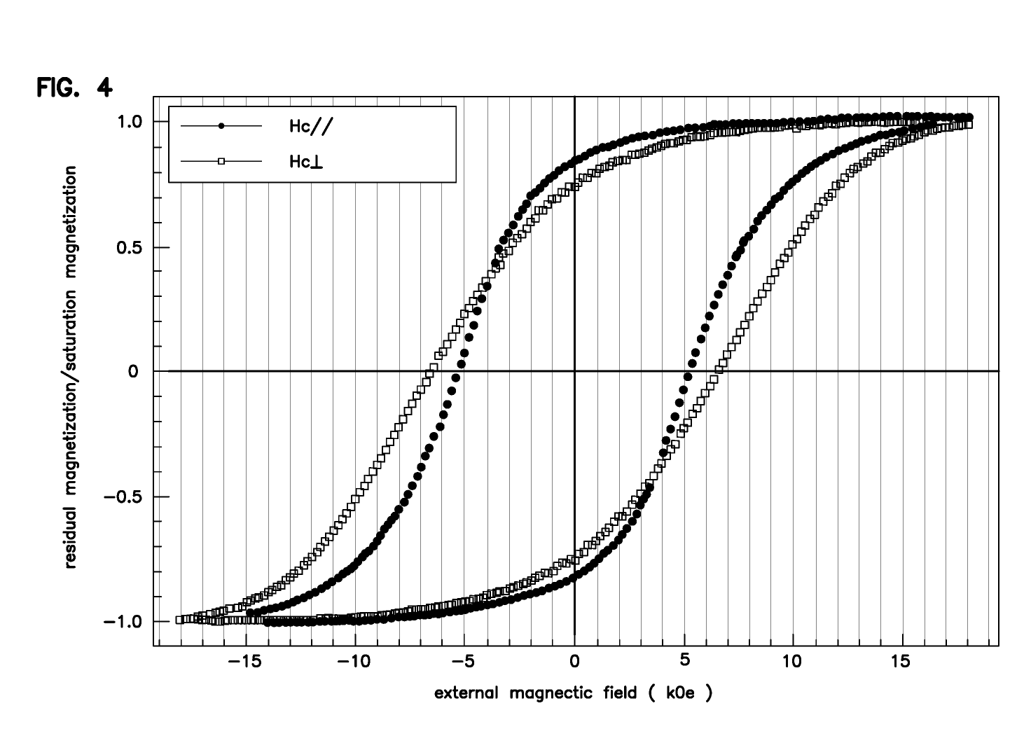

In particular, because of the low solubility of Ag in FePt alloy, Ag segregation is formed in the grain boundaries or the surface of the crystallites of the ordered FCT structure of the FePt alloy. Therefore, the magnetic material formed by the method of this invention has great isolation and thereby results in reduction of noise among crystallites when used in the PMR medium. Moreover, from the hysteresis loops shown in FIG. 4, the out-of-plane coercive field (Hc⊥) is 6.6 kOe.

In conclusion, by forming the layer of the first alloy having the meta-stable phase of the FCC structure and the layer of the third metal, the annealing temperature in the method of this invention for ordering a disordered alloy can be reduced to about 350° C. so that the aforesaid drawback of requiring a high annealing temperature in the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for ordering a disordered alloy, comprising:
(a) forming a layer of a first alloy on a substrate, the first alloy being composed of a first metal and a second metal, and having a meta-stable phase of a face-centered cubic (FCC) crystal structure;
(b) forming a layer of a third metal on the layer of the first alloy to form a layer unit including the layer of the first alloy and the layer of the third metal; and
(c) annealing the layer unit to cause interdiffusion of atoms of the first and third metals between the layer of the first alloy and the layer of the third metal so as to form an ordered second alloy composed of the second and third metals,
wherein the first metal is insoluble in the second alloy composed of the second and third metals, and has a diffusion constant greater than those of the second and third metals.

2. The method of claim 1, wherein the first metal is selected from the group consisting of Au and Ag.

3. The method of claim 1, wherein the second metal of the layer of the first alloy and the third metal of the layer of the third metal are independently selected from a first group consisting of Fe, Co, and Ni or a second group consisting of Pt and Pd, with the proviso that the second metal and the third metal cannot be selected from the same group at the same time.

4. The method of claim 3, wherein the second metal of the layer of the first alloy is selected from the second group consisting of Pt and Pd, and the third metal of the layer of the third metal is selected from the first group consisting of Fe, Co, and Ni.

5. The method of claim 4, wherein the first metal is Ag, the second metal is Pt, and the third metal is Fe.

6. The method of claim 5, further comprising a step of repeating steps (a) and (b) so as to form a plurality of layer units, wherein a total layer thickness of the layer units ranges from 5.0 nm to 21.0 nm.

7. The method of claim 5, wherein an atomic ratio of the first metal to the second metal ranges from 0.3 to 1, and an atomic ratio of the third metal to the second metal ranges from 1 to 1.1.

8. The method of claim 5, wherein the annealing temperature ranges from 300° C. to 350° C.

9. A magnetic material made by the method of claim 1, comprising:
a plurality of magnetic crystallites composed of a second alloy that includes second and third metals and that has an ordered crystal structure, said second metal of said second alloy being selected from the group consisting of Pt and Pd, said third metal of said second alloy being selected from the group consisting of Fe, Co, and Ni; and
a segregation composed of Ag or Au and formed in the grain boundaries or the surface of said magnetic crystallites.
